(19) United States
(12) Patent Application Publication
(10) Pub. No.: US 2024/0066600 A1
(43) Pub. Date: Feb. 29, 2024

(54) METHOD FOR DISCHARGING PARTICULATE BUILDING MATERIAL IN A 3D PRINTER

(71) Applicant: LAEMPE MOESSNER SINTO GMBH, BARLEBEN (DE)

(72) Inventors: JANOSCH MUENZER, MALTERDINGEN (DE); FRANK WEDEMEYER, ZELL IM WIESENTAL (DE); RUDOLF WINTGENS, SCHOPFHEIM (DE)

(21) Appl. No.: 18/263,710

(22) PCT Filed: Mar. 22, 2022
(86) PCT No.: PCT/DE2022/000029

§ 371 Date: Aug. 1, 2023

(30) Foreign Application Priority Data
Mar. 24, 2021 (DE) 10 2021 001 534.7

(51) Int. Cl. B22F 10/37; B22F 10/28; B22F 12/52; B22F 12/90; B29C 64/153; B29C 64/329; B29C 64/393; B33Y 10/00; B33Y 50/02

(52) U.S. Cl. CPC B22F 10/37; B22F 10/28; B22F 12/52; B22F 12/90; B29C 64/153; B29C 64/329; B29C 64/393; B33Y 10/00; B33Y 50/02

(57) ABSTRACT

A method for discharging particulate building material in a 3D printer to be applied more evenly. A building material curtain of particulate building material and/or an accumulation of building material is optically monitored in a work step of discharging the particulate building material in an area of the building material curtain between the applicator and the construction site and/or a point of impact of the particulate building material on the construction site at which the building material accumulation is created. An image is generated and/or at least one dimension is determined to be compared with an associated reference image and/or a specified reference value. If any deviation is detected, at least one discharge parameter for the discharge of the particulate construction materials is changed.

The invention relates to a method for discharging particulate building material in a 3D printer, in which particulate building material is discharged from an applicator in the form of a curtain of building material onto a construction site.

So-called application of the particulate building material to a building site is understood to mean both the discharge of the particulate building material onto the surface of the building site and the smoothing of the discharged particulate building material on the building site.

In particular, the present invention influences the discharge of the particulate building material onto the building site.

In particular, the uniform discharge of the particulate building material on a construction site in a 3D printer is to be monitored and irregularities in the discharge of the particulate building material discharged from an applicator are to be detected. In the event that such irregularities are detected, they are automatically reduced or eliminated using appropriate measures. For this purpose, corresponding parameters for the discharge of the particulate building material are influenced.

It is known to use so-called 3D printing or a so-called 3D printing process to produce individual or serial components, workpieces or molds. In such printing processes, three-dimensional components or workpieces are produced in layers.

The structure is computer-controlled from one or more liquid or solid—materials according to specified dimensions and shapes. Specifications for the components or workpieces to be printed can be provided, for example, by so-called computer-aided design systems (CAD).

When printing the 3D structures or 3D components, physical or chemical hardening processes or a melting process take place in a particulate building material, which is also referred to as molding material. Building materials or molding materials such as plastics, synthetic resins, ceramics, minerals, sand and metals are used as materials for such 3D printing processes.

Various manufacturing process sequences are known for the implementation of 3D printing processes.

However, several of these procedural sequences include the procedural steps shown below by way of example:
Partial or full-surface application of particulate building material, also referred to as particulate material or powdered building material, on a so-called construction field in order to form a layer of non-solidified particulate material, the partial or full-surface application of particulate building material comprising the removal and smoothing of the particulate building material;
Selective solidification of the applied layer of non-solidified particulate building material in predetermined partial areas, for example, by selective compacting, printing or application of treatment agent, such as a binder or use of a laser;
Repetition of the previous process steps in a further layer level for the layered construction of the component or workpiece. For this purpose, it is provided that the component or workpiece, which is built up or printed on in layers on the construction area, is lowered with the construction area by one layer level or layer thickness or the 3D printing device is raised by one layer level or layer thickness compared to the construction area before a new layer is applied over part or all of the area;
Subsequent removal of loose, unconsolidated particulate build material surrounding the manufactured component or workpiece.

Various methods for generating a 3D structure or for discharging and applying particulate construction material to a construction field to generate a 3D structure are known from the prior art.

A method and a device for applying fluids and their use are known from DE 10117875 C1.

The method for applying fluids relates in particular to particulate material which is applied to an area to be coated, the fluid being applied to the area to be coated in front of a blade, seen in the direction of advance of the blade, and then the blade being moved over the applied fluid.

The object is to provide a device, a method and a use of the device with which a distribution of fluid material that is as even as possible can be achieved on an area to be coated.

The solution is that the blade oscillates in the manner of a rotary movement. The fluid applied to the area to be coated is fluidized by the oscillating rotary movement of the blade. As a result, not only can particle material with a strong tendency to agglomerate be applied as evenly and smoothly as possible, but it is also possible to influence the compression of the fluid by the vibration.

In a preferred embodiment, provision is made for the fluid to be applied in excess to the area to be coated. Thus, the constant movement of the blade, which oscillates in the manner of a rotary movement, homogenizes the excess fluid, seen in the direction of forward movement of the blade, in front of the blade in a fluid/particulate roller formed by the forward movement of the blade. This allows any voids between individual clumps of particles to be filled and larger clumps of particulate material are broken up by the roller movement.

A disadvantage of this known prior art is that when the particulate building material is discharged onto a building site, the quantity of the particulate building material required to form a layer is insufficiently regulated. This leads to different amounts of the particulate building material in front of a means for smoothing the particulate building material and thus, for example, to different pressure conditions on the layers located below the layer currently to be applied. This leads to disturbances in the uniform structure of the layers and to a deterioration in the quality of the 3D structure to be produced.

Thus, there is a need for an improvement in the known art and thus for an improved method for dispensing particulate build material in a 3D printer.

The object of the invention is to specify a method for discharging particulate building material in a 3D printer, with which the particulate building material is discharged more evenly.

The method is intended to improve both uniformity in height of the discharged layer of particulate build material and uniformity of density within the layer of discharged particulate build material. Thus, after the discharged particulate building material is smoothed, a better quality of the applied layer of particulate building material is achieved.

The object is achieved by a method with the features according to patent claim 1 of the independent patent claims. Further developments are specified in the dependent patent claims.

Provision is made for the use of an optical control system when the particulate building material is discharged onto the building site in a 3D printer according to the present method.

For this purpose, it is provided that the particulate building material is optically monitored during a work step of removing the particulate building material by means of an applicator. This optical monitoring preferably takes place in an area between the applicator and the construction site, in which a so-called building material curtain is formed by the particulate building material from the applicator. This curtain of building material, consisting of particulate building material, which moves from the applicator to the construction site due to gravity or which falls, has a width that depends on the applicator. In an embodiment in which an orderer can supply the entire width of the building site with particulate building material, the building material curtain has the width of the entire usable building site.

In an alternative embodiment, an applicator has only part of the width of the construction field. In these cases, it is possible to work with several applicators, which together cover the entire width of the construction area or can discharge particulate construction material over the entire width of the construction area. In this case, the construction material curtain also has only part of the width of the construction field.

This curtain of building material also has a thickness that is also dependent on the client. Furthermore, the building material curtain has a height which can correspond to the shortest distance between the applicator and the surface of the building site. Since the applicator moves over the surface of the construction area when discharging the particulate construction material, it is possible that the curtain of construction material is not perpendicular to the surface of the construction area, but instead has an angle deviating from the perpendicular to the construction area. In this case, the height of the building material curtain is greater than the shortest distance between the applicator and the surface of the building site.

As is known from the prior art, the discharged particulate building material is smoothed by means of a means for smoothing the particulate building material, creating a uniform strength or thickness of the particulate building material in the layer currently to be applied on the surface of the construction field.

Such a means for smoothing the particulate building material can be, for example, a scraper blade, an oscillating blade, a knife, a squeegee or comparable means of a 3D printer, by means of which the discharged particulate building material is smoothed.

As is known from the prior art, the means described above move at a constant distance from the construction area and horizontally across the construction area. At the same time, the applicator is also moved at a constant distance from the construction area and horizontally across the construction area. It can be provided here that the applicator is arranged at a constant distance from the means for smoothing, which distance does not change when they move together over the construction area.

The height or layer thickness of the particulate building material applied can have a value which is between 0.5 times and 6 times the average particle diameter of the particulate building material. In order to achieve a height or layer thickness of 0.5 times the average particle diameter of the particulate building material, the particulate building material must be discharged onto the construction site and compacted.

The mean particle diameter of the particulate building material is, for example, at a value of about 0.14 mm.

Particulate building material is generally understood to be a collection of individual particles of a substance or a mixture of substances, each particle having a three-dimensional extension. Since these particles can predominantly be understood as round, oval or also elongated particles, it is possible to specify an average diameter for such a particle, which is usually in the range between 0.1 mm and 0.4 mm. Such a particulate building material has fluid properties.

The particulate building material to be discharged by the applicator forms what is known as the building material curtain between the applicator and the surface of the construction site. The width of the building material curtain usually corresponds to the width of the outlet opening or the gap on the applicator. The thickness of the curtain of build material is affected by the amount of particulate build material to be discharged by the applicator per unit time. As the amount of particulate build material to be discharged by the applicator per unit time increases, so does the thickness of the curtain of build material, and vice versa.

It is thus possible, by determining the thickness of the curtain of building material, to infer the amount of particulate building material currently being discharged by the applicator and thus to regulate the amount of particulate construction material discharged by the applicator by determining the thickness of the curtain of construction material.

When it hits the construction area or when it comes into contact with the surface of the construction area, the construction material curtain forms a geometric shape at a so-called point of impact, which is usually triangular when viewed from the side, with one side of this triangle being aligned horizontally, i.e., parallel to the surface of the construction area and facing this surface of the construction area. This condition is hereinafter referred to as so-called building material accumulation. In a three-dimensional view, this accumulation of building material has the shape of an imaginary triangular prism, for example, in which the three rectangular lateral surfaces each lie with their longitudinal extensions at a right angle to a direction of movement of the applicator over the building site. In addition, the longitudinal extensions are aligned parallel to the surface of the construction site.

This accumulation of building material forms depending on the amount of particulate building material discharged. In the event that a larger quantity of the particulate building material is discharged by the applicator, the building material accumulation will have at least a greater height and/or greater width than if a smaller quantity of the particulate building material is discharged.

It is thus also possible, by determining the dimensions of the accumulation of building material, to infer the amount of particulate building material currently being discharged by the applicator and thus to regulate the quantity of particulate construction material discharged by the applicator by determining the dimensions of the accumulation of building material.

The dimensions of such a prism-shaped accumulation of building material with a triangular base and top surface include its maximum width in the lower area of the accumulation of building material and its maximum height. In addition, at least one angle of the triangular base and top surface of the triangular prism-shaped accumulation of building material can also be used as a dimension. Such an angle can be, for example, a so-called slope angle, which describes an increase in the accumulation of building material compared to the flat surface of the building site.

By specifically influencing the amount of building material to be removed per unit of time, it is possible to improve the uniformity of the layer to be applied to the building site. If this improvement in the uniformity of the layer of particulate building material achieves a corresponding level of accuracy or quality, this has a positive effect on the quality of the 3D structure to be produced. In special cases, it may then be possible to dispense with a smoothing agent for certain 3D printing applications.

In such an application, the applied layer of non-solidified particulate building material can be selectively solidified in predetermined partial areas immediately after the application has discharged the particulate building material.

Provision is made for optical monitoring of the building material curtain, which consists of particulate building material, to take place in a work step of discharging the particulate building material onto the building site. Here, for example, the building material curtain is recorded from at least one direction or perspective by means of one or more cameras.

Provision is also made for optical monitoring of the accumulation of building material in the form of a triangular prism at the impact point of the particulate building material on the construction site. Here, for example, the building material accumulation is recorded from at least one direction or perspective by means of one or more cameras. This direction or perspective can be a side view or a perspective view of the triangular prism-shaped accumulation of building material at the point of impact.

In general, it can be said that an image of the curtain of building material and/or the accumulation of building material at the point of impact is generated by a suitable means for optically monitoring the particulate building material to be discharged in a work step of discharging the particulate building material. Such a means can be, for example, at least one camera, a laser, a combination of projector and/or laser and/or camera or a comparable image recording device.

In an alternative, it is provided that an image of a partial area of the building material curtain and/or the building material accumulation is generated. For optical monitoring of the particulate building material to be discharged according to the method, it is sufficient in an alternative of the method to generate an image of only a part or a partial area of the building material curtain and/or the building material accumulation and to process it according to the method.

Such an image of the curtain of build material and/or the pile of build material may show, for example, a side view or a front view of the curtain of build material and/or a side view or a front view of the pile of build material. Alternatively, a perspective view or perspective view of the building material curtain and/or the building material accumulation can also be generated as an image.

A 3D recording device consisting of a number of cameras or 3D cameras, for example using strip light projection, can also be used.

If suitable means for optical monitoring of the particulate building material to be discharged, i.e., the building material curtain and/or the building material accumulation, are arranged at different points in each case aligned with the building material curtain, a means for optical monitoring is selected according to the method, for example. There is also the possibility, controlled by the present method, of selecting or switching to another means of optical monitoring, such as a camera, for generating the image of the building material curtain. It is also planned to use several means of visual surveillance at the same time. Thus, for example, images of the building material curtain can be generated from different perspectives at the same time. This gives the opportunity to determine several dimensions of the building material curtain at the same time. The same applies to the accumulation of building materials.

For example, a dimension of the width of the curtain of building material can be determined with a camera that generates a frontal view, but not an angle of the curtain of building material that deviates, for example, from the perpendicular. To determine this angle of the curtain of building material, a camera is selected which produces a side view of the curtain of building material, by means of which, on the other hand, the width of the curtain of building material cannot be determined.

Both the width of the building material curtain and the angle of the building material curtain can be determined by means of a camera that generates a perspective image of the building material curtain. For this purpose, however, appropriate image processing algorithms, for example for perspective rectification, are to be provided in order to determine correct values for the width and the angle of the building material curtain.

The resolution and recording rate of the camera used must be correspondingly high in order to generate a sufficiently accurate image at any speed at which, for example, a delivery person and thus also, for example, the building material curtain moves across the construction site. In this context, a sufficiently precise image of the building curtain of building material is understood here, which can be further processed according to the present method, i.e., for example, for an image comparison or a determination of dimensions of the curtain of building material, such as a height and/or a width and/or an angle of the building material curtain.

Depending on the mounting position, the camera can be equipped with a wide-angle lens or provide a suitable perspective in order to record or image the entire area of the building material curtain and/or the building material accumulation.

It is also planned to use suitable software that can be used to normalize the recordings or images or to enable post-processing with regard to contrast or filtering. In any case, the aim is to ensure that the images of the building material curtain and/or the building material accumulation are of sufficient quality for subsequent process steps.

It is also provided that, for example on the basis of the images generated during optical monitoring, such as individual images or a video from one or more views of the building material curtain and/or the building material accumulation, geometric dimensions of the building material curtain consisting of particulate building material and/or the building material accumulation are determined.

Here, for example, basic dimensions of the building material curtain or information about the outer contour of the building material curtain can be determined.

The basic dimensions of the build material curtain include dimensions such as a width, a height, or an angle of the build material curtain.

With regard to the outer contour of the building material curtain, for example, its shape and its thickness can be determined. An exemplary shape of a curtain of building material may be a cuboid shape. Alternatively, the building material curtain can be a trapezoidal prism, with the width of the particulate building material discharged onto the building site being greater than the width of the particulate building material emerging from the applicator, for example. Likewise, the thickness of the particulate building material discharged onto the construction site can be greater than the thickness of the particulate building material emerging from the applicator.

In addition to such dimensions, dimensions along the building material curtain, ie in its longitudinal extension, can be recorded. Here, for example, different thicknesses of the curtain of construction material can be determined at different points along the curtain of construction material. Additionally, a maximum and/or minimum thickness of the curtain of build material or an average thickness of the curtain of build material may be determined.

With regard to the building material accumulation, the dimensions can be a maximum width in the lower area of the building material accumulation, i.e., an approximately horizontal side length of the imaginary triangle, and a maximum height of the triangular prism-shaped building material accumulation, such as a height in the imaginary triangle, whereby the height above the horizontal side length is meant. In addition, for example, an interior angle of the triangular base and top surface of the triangular prism-shaped accumulation of building material or a slope angle of the accumulation of building material can be determined as a dimension and used for a later comparison with a predetermined value for such a dimension.

Since the particles of the particulate building material in the building material curtain are constantly moving as they move from the applicator to the construction site these particle movements result in dynamic changes within the building material curtain. The reason for this are different speeds or falling speeds and collisions of the particles of the particulate building material. Dynamic changes also occur in building material accumulation.

These dynamic changes or disruptive particle movements in the curtain of building material and/or the accumulation of building material can affect the quality of the discharged layer of particulate building material on the surface of the building site. If a connection between disturbing particle movements and, for example, the amount of particulate building material to be discharged per unit of time is detected in test runs, the discharge parameter amount of particulate building material to be discharged per unit of time can be specifically influenced by the method, in the event that the method detects an unwanted deviation within the building material curtain and/or the building material accumulation when comparing the generated image of the building material curtain and/or the building material accumulation with an associated reference image.

It is envisaged to subdivide the longitudinal extent of the building material curtain into partial areas or sections and to generate associated images within these partial areas. The same can also be done with the building material accumulation. For example, section-related dimensions such as a height and/or a thickness and/or an angle of, for example, the building material curtain are determined from these images. In this case, all sub-areas in their sum or their juxtaposition can map the entire length of the building material curtain or the building material accumulation in its or their longitudinal extension.

Provision is also made for the images of the partial areas to be compared with associated reference images for the evaluation or analysis of deviations.

Provision is also made for a specific dimension to be compared with a predetermined value or reference value for this dimension. If a deviation between the dimension and the specified value or reference value for this dimension is determined during this comparison, which is above a specified tolerance limit, then at least one parameter for the discharge of the particulate building material (substrate application parameter), which is referred to below as the discharge parameter, is changed.

As an alternative to a comparison of a specific dimension with a predetermined value or reference value for this dimension, or in addition to this comparison, it is possible to compare the generated image with an associated reference image. If such a comparison, such as an image comparison, reveals deviations that are above a predetermined tolerance limit, at least one parameter for the discharge of the particulate building material, i.e., a discharge parameter, is changed and the quantity of the particulate building material to be discharged is regulated or controlled or changed in this way. The aim is for the currently generated images to be brought into agreement with the reference images in order to improve the quality when applying a layer of the particulate building material, i.e., to improve uniformity with regard to the height or layer thickness of the applied layer of the particulate building material.

If, for example, a comparison of a dimension with its reference value shows that the thickness of the curtain of building material falls below the specified reference value for the thickness of the curtain of building material, a discharge parameter that determines the amount of particulate construction material to be discharged per unit of time or per area is increased. A larger quantity of the particulate building material is thus poured out or discharged from an applicator. As a result, it is to be expected that the thickness of the curtain of building material will increase again, since the thickness is directly related to the amount of particulate building material to be discharged.

In alternative comparisons of a specific dimension with its reference value, the length, height or a determined angle of the building material curtain or a length, width, height, interior angle or slope angle of the triangular base or top surface of the building material accumulation can also be used.

When a so-called fluidizer is used to discharge the particulate building material, it is intended that the discharge parameters of the quantity of particulate building material to be discharged per unit of time or per area be influenced by a different number of so-called porous gas outlet means in the fluidizer being controlled or acted upon by means of a pressurized gas. Another way of influencing these discharge parameters is to change the pressure of the gas. Another alternative is to change the gas pressure periodically over time, which can be done, for example, with an adjustable frequency.

Provision is also made for several discharge parameters to be influenced at the same time as a result of the result of one or more deviations determined between one or more dimensions and their correspondingly specified values.

It is thus possible, for example, to change the discharge parameter of a movement speed of the working means of the 3D printer over the surface of the construction field and at the same time to increase the quantity of particulate construction material discharged from an applicator.

These tools of the 3D printer include in particular an applicator for the particulate building material as well as the means for smoothing the discharged building material such as a scraper blade, an oscillating blade, a knife or a squeegee.

By subdividing the optical monitoring of the building material curtain into sub-areas, it is possible to change the discharge parameters for each sub-area according to the deviations of the dimensions from the specified values in this sub-area. This presupposes that the means for discharging the particulate building material, such as an applicator, are subdivided accordingly or arranged in multiples accordingly. Such a multiple arrangement of these means can take place in such a way that the dischargers are arranged in a row next to each other or in at least two rows and offset from one another. It is clear to a person skilled in the art that it must always be possible by means of such an arrangement of the means that the particulate building material can be applied evenly in one layer and in all required areas on the building site.

It is also planned to analyze the building material curtain with regard to the dynamic behavior of the particles. The particulate building material is in motion or flowing during the operation of removing the particulate building material in the curtain of building material. The basic dimensions of the building material curtain and/or the outer contour of the building material curtain are constantly changing. These dynamic changes are recorded, for example, over time, for example by means of a video recording or a sequence of images or an image stream.

An evaluation of these dimensions that change over time, such as a thickness of the building material curtain, provides information about the area of the change in thickness, i.e., a minimum and a maximum of the dimension thickness. In addition, such a change in thickness can be analyzed over time. In this way it can be determined, for example, that the change in thickness between its minimum and its maximum takes place periodically. From this change over time, a mean frequency can be determined, for example, with which the process of changing the thickness in the building material curtain is repeated.

Reference thickness changes determined in test series can be used to make statements about the influence on the quality of the applied layer of the particulate building material as a function of the frequency of the thickness change by means of a frequency comparison between the frequency of the thickness change and the determined reference frequencies.

For example, values determined in test runs about such changes in thickness and the associated reference frequencies can be related to the quality to be achieved for the layer of particulate building material to be produced. It is thus possible to influence discharge parameters at certain changes in thickness or frequencies of such changes in thickness in such a way that the change in thickness decreases or the frequency of the change in thickness changes in order to improve the quality of the current layer of the particulate building material to be applied.

For example, a quantity of the particulate building material to be discharged per unit of time can be mentioned as a changeable discharge parameter.

Furthermore, it is possible to change the amount of particulate building material per area. In addition, such a change in the discharge quantity per unit of time and/or per area can be changed over time, with this change being able to take place with a specific or variable or with a frequency that changes over time. For example, the value of the set frequency can increase or decrease over time, or increase and decrease successively, and so on. It is provided, for example, to counteract the change in thickness over time in the curtain of construction material by changing the discharge parameter quantity of particulate building material per unit of time over time and at least to reduce or eliminate the change in thickness over time.

The particle movement of the particulate building material or the kinematics can thus be changed in a targeted manner in order to prevent quality disruptions when the particulate building material is applied. This influencing of the particle movement of the particulate building material can take place differently both for the entire curtain of building material and also for sections of the curtain of building material if the optical monitoring is already carried out separately in these sections.

The foregoing features and advantages of this invention will be better understood and appreciated after a careful study of the following detailed description of preferred non-limiting example embodiments of the invention herein, with the accompanying drawings, which show:

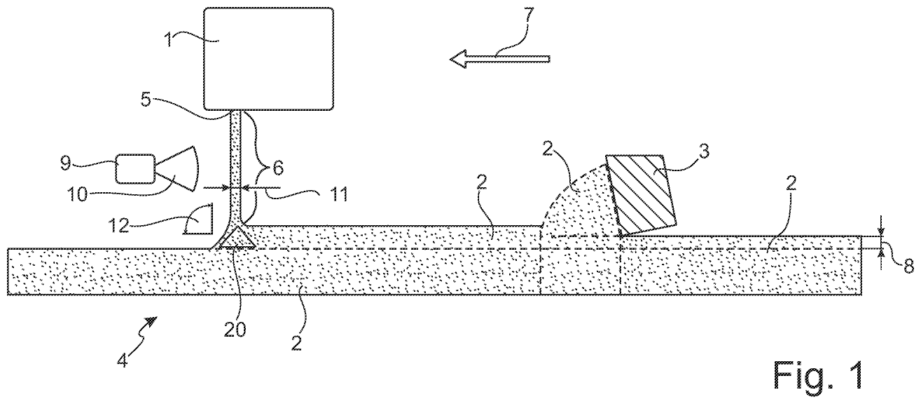

FIG. 1: means for discharging the particulate building material and a means for smoothing the particulate building material over a building field;

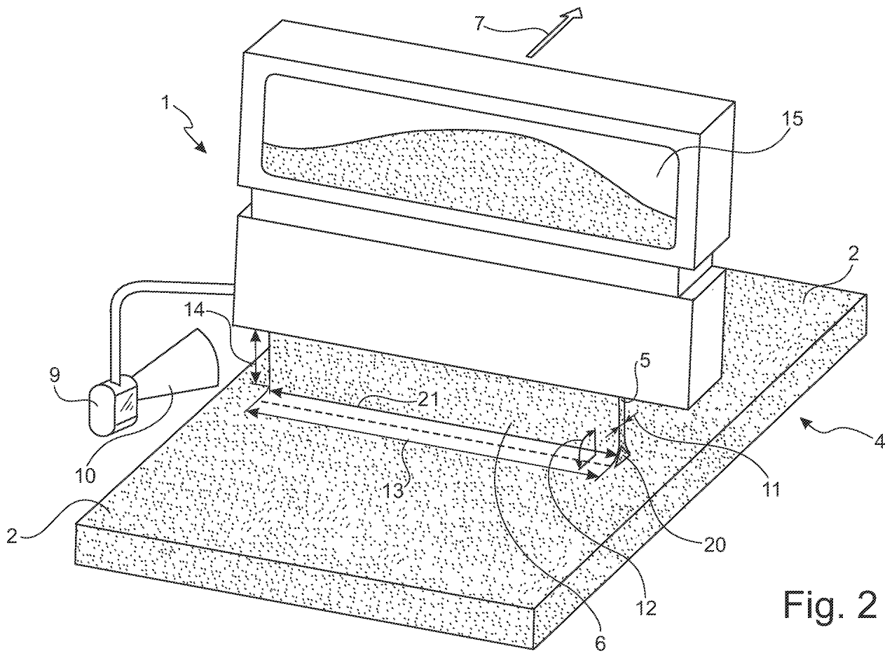

FIG. 2: an exemplary means for discharging the particulate building material like an applicator in a 3D printer;

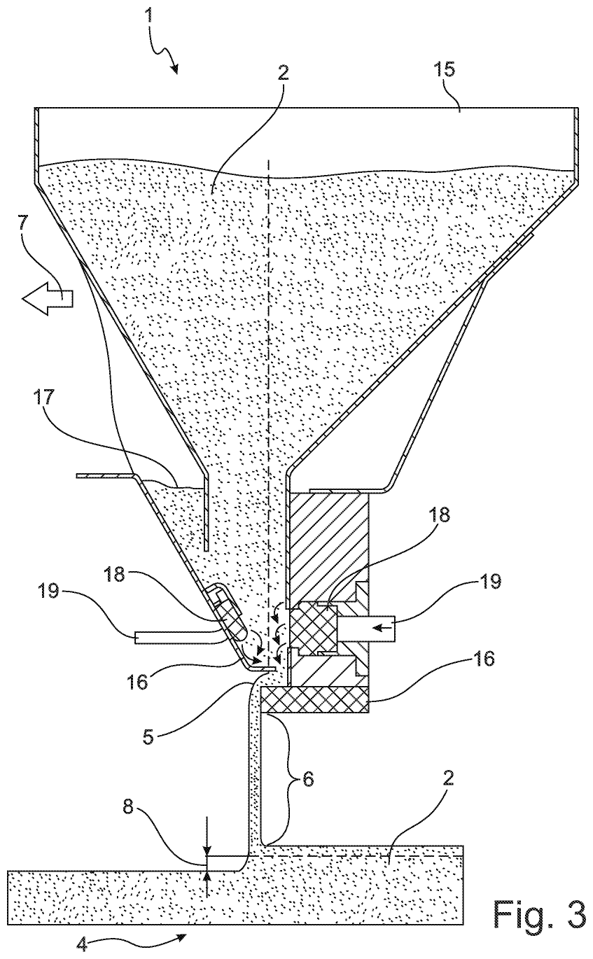

FIG. 3: a further exemplary arrangement for discharging the particulate building material in a 3D printer; and

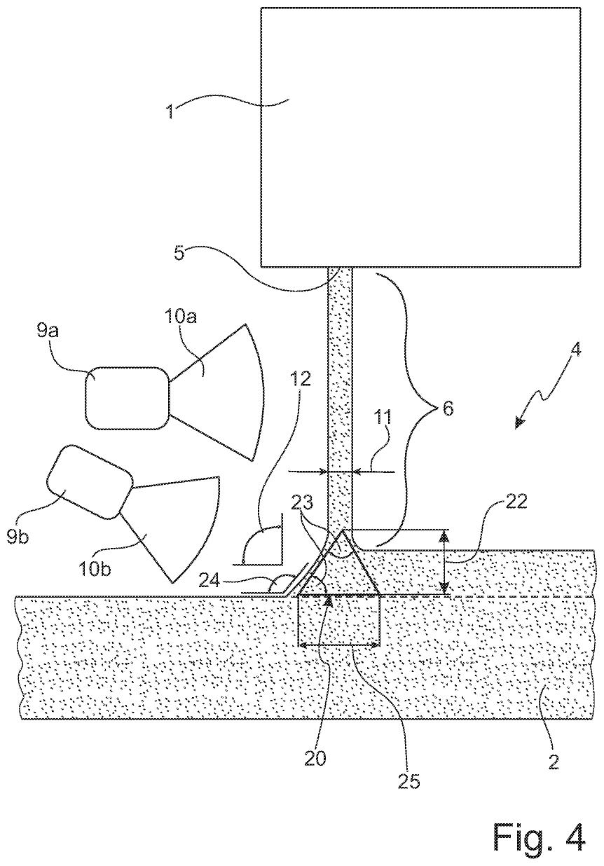

FIG. 4: an enlarged partial view of the area of the building material curtain and the building material accumulation on the construction site.

FIG. 1 shows a means 1 for discharging the particulate building material 2 and a means 3 for smoothing the particulate building material 2 over a building field 4.

Such a means 1 for discharging the particulate building material 2 can, for example, be a so-called applicator 1, while the means 3 shown for smoothing the particulate building material 2 is, for example, a blade.

The applicator 1 has a storage container 15, not shown in FIG. 1, in which the particulate building material 2 to be discharged is stored. An outlet 5 for discharging the particulate building material 2 can be arranged at the lower end of the applicator 1. In order to prevent particulate building material 2 from escaping from the applicator 1 in an uncontrolled manner, the discharger 1 has a corresponding closure means, which is not shown in FIG. This closure means is designed in such a way that it can open and close the outlet 5 or a corresponding opening in the lower area of the applicator 1.

In the event that particulate construction material 2 is to be discharged from the applicator 1 and thus discharged onto the construction area 4, the closure means is opened. The particulate building material 2 is discharged and reaches the surface of the construction field 4 in the form of a so-called building material curtain 6. This process of discharging particulate building material 2 is shown in FIG. The amount of particulate building material 2 to be discharged is influenced and controlled by changing a discharge parameter. Here, a discharge parameter can be the amount of particulate building material 2 to be discharged per unit of time, while another discharge parameter is the amount of particulate building material to be discharged per area.

If, for example, the amount of particulate building material 2 to be discharged per unit of time and the speed of movement of the applicator 1 in the direction of movement 7 over the construction area 4 are controlled accordingly, the particulate construction material 2 is discharged onto the surface of the construction area 4 very evenly and therefore with high quality.

As can be seen in FIG. 1, more particulate building material 2 is removed than would be necessary to achieve layer thickness 8. Since the means 3 for smoothing is also moved in the direction of movement 7 over the building field 4, an accumulation occurs due to the excessively discharged particulate building material 2.

The building material curtain 6 is optically monitored by means of optical monitoring 9, such as a camera 9, which is aligned with its recording area 10 to the building material curtain 6, and corresponding images are created by taking pictures or video recordings. The camera 9 is arranged in FIG. Alternatively, the camera 9 can also be arranged in a way that differs from the illustration in FIG. 1 in such a way that the camera 9 provides a side view or a perspective view. It is also possible to arrange several cameras 9 in order to provide several views, such as a front view of the construction material curtain 6 and a side view of the construction material curtain 6.

Between the surface of the building field 4 and the building material curtain 6 is determined using suitable image processing software. These dimensions are related to the amount of particulate building material 3 to be discharged or the speed of movement in the direction of movement 7. It can generally be assumed that an increase in the value for the thickness 11 indicates an increase in the amount of particulate building material 2 during the discharge step. It can also generally be assumed that a decrease in the value for the angle 12 indicates an increase in the movement speed of the applicator 1 during the discharge work step.

Even if FIG. 1 only shows the case of an angle 12 of approximately 90 degrees, the angle 12 can assume smaller values. For example, it can be assumed that the angle 12 decreases in the direction of movement 7 as the movement speed of the delivery carrier 1 increases.

Other dimensions of the building material curtain 6 to be determined according to the method, such as its length 13 or its height 14, are not shown in FIG. 1.

If, during a comparison of the currently determined dimensions, for example the values for the thickness 11 and/or the angle 12, it is established that these deviate from the associated predefined values, then the discharge parameters are changed. These discharge parameters are, for example, the amount of particulate building material 2 to be discharged per unit of time and the speed of the working means of the 3D printer in the direction of movement 7. The working means here are the discharger 1 and the means 3 for smoothing, i.e., a blade, for example.

For example, in the event that the value for the thickness 11 is greater than the associated predefined value, the speed in the direction of movement 7 can be increased, for example. Likewise, the discharge parameter quantity of the particulate building material 2 to be discharged per unit of time can be reduced until the dimensions again correspond to the specified values, with a tolerance range usually being defined. This reduction in quantity can be achieved, for example, by influencing the size of the outlet 5 on the applicator 1.

The process-related changes in the discharge parameters described for the application of the particulate building material 2 can also take place differently in some areas. Of course, this presupposes that, for example, several applicators 1 for discharging the particulate building material 2 in the 3D printer and/or that several means 3 for smoothing are arranged in the 3D printer.

FIG. 1 also shows the building material accumulation 20 with its, for example, triangular top surface or base surface. The triangle shown is intended as an aid to show how an observer can imagine the triangular-prism-shaped building material accumulation 20 with its imaginary triangular base and top surface in the area of the particulate building material 2 striking the building site 4. The body edges of the triangle shown are of course not recognizable in the particulate building material 2, but can be determined by a procedural evaluation of the recordings resulting from the optical monitoring of the particulate building material 2 accumulation 20 using suitable software. Further dimensions of the building material accumulation 20 can then be determined from this.

FIG. 2 shows a means for discharging the particulate building material 2 such as an applicator 1 in a 3D printer, which can be moved horizontally over the building field 4 in the direction of movement 7.

The applicator 1 has a storage container 15 for the particulate building material 2 to be stored. In its lower region, the applicator 1 has a longitudinally extending outlet 4 for letting out the particulate building material 2, which then moves or falls in the form of the building material curtain 6 in the direction of the surface of the building field 4.

As already described, it is provided that images of the construction material curtain 6 are generated by means of a camera 9 whose recording area 10 is aligned with the construction material curtain 6. For this purpose, the camera 9 can show, for example, a side view or a frontal view of the building material curtain 6. A further possibility for aligning the camera 9 consists in aligning a perspective view of the construction material curtain 6, as is shown in FIG. For this purpose, the camera 9 is, for example, permanently connected to the applicator 1 and thus moves with the applicator 1 over the construction area 4.

After the images have been generated by the camera 9, the displayed dimensions of the building material curtain 6 such as its thickness 11, its width 13, its height 14 or the angle 12 between the surface of the building site 4 and the building material curtain 6 can be determined.

It is also shown in FIG. 2 with its imaginary triangular top surface or base surface. Also shown is the length 21 of the building material accumulation 20, which essentially corresponds to the length 13 of the building material curtain 6.

FIG. 3 shows a means 1 for discharging the particulate building material 2 in a 3D printer, which can be moved horizontally over the building field 4 in the direction of movement 7. A means 1, which is also referred to as a so-called fluidizer, is shown in a snapshot, in which particulate building material 2 exits through the outlet 5 and reaches the surface of the building field 4 as a building material curtain 6, in order to form a new layer of the particulate building material 2 there with a layer thickness 8. The means 3 still required for this is not shown in FIG. 3.

The applicator 1 has a funnel-shaped storage container 15 for storing the particulate building material 2. This funnel-shaped reservoir 15 is designed to be longitudinal, with its length being a multiple of its width.

The reservoir 15 has an opening or an outlet 5. In the lower area of the funnel-shaped reservoir 15, two blocking means 16 are arranged, through which the outlet 5 is formed. In the representation of FIG. 3, a ventilation gap 17 is formed by the left blocking means 16 on its upper side.

Such an arrangement of the blocking means 16 prevents particulate building material 2 from getting onto the building site 4 unintentionally, since a blocking cone, closing the path, is formed from the particulate building material 2 at the outlet 5.

Application of the particulate building material 2 to the building site 4 is achieved in that the particulate building material 2 is fluidized in the area of the outlet 5. For this purpose, provision is made for arranging at least one porous gas outlet means 18 in this area. Two porous gas outlet means 18 are arranged on the side walls of the storage container 15 in FIG. These two porous gas outlet means 18 each have a gas connection 19 which is connected to an external unit, not shown, which generates a gas whose gas pressure can be controlled.

Each porous gas outlet means 18 has a gas-permeable porous material on its side facing the particulate building material 2.

The gas, whose gas pressure can be controlled by the external unit, exits the porous gas outlet means 18 through the gas-permeable porous material in the direction of the particulate building material 2 in a uniformly distributed manner and flows through the particulate building material 2. This outflowing gas is shown in FIG. 3 by several small arrows on the porous gas outlet means 18. The particulate building material 2 is fluidized by this escaping gas, as a result of which the particulate building material 2 is discharged via the outlet 5, forming the building material curtain 6, and reaches the building site 4.

Only one porous gas outlet means 18 is required to fluidize the particulate building material 2. However, if the gas flows into the particulate building material 2 from two sides via two porous gas outlet means 18, the effect of fluidizing the particulate building material 2 is intensified and a larger quantity of the particulate building material 2 is discharged via the outlet 5.

In order to control the amount of particulate building material 2 to be discharged, the pressure of the gas fed into the porous gas discharge means 18 is varied. For example, the fluidization of the particulate building material 2 can be increased or improved by means of a greater gas pressure, as a result of which more fluidized particulate building material 2 can exit through the outlet 5 and, for example, the thickness 11 of the building material curtain 6 increases.

Alternatively, the fluidization of the particulate building material 2 can be reduced or worsened by means of a lower gas pressure, as a result of which less particulate building material 2 is discharged.

A thickness dimension 11 of the building material curtain 6 can thus be controlled by controlling the gas pressure or the number of porous gas outlet means 18 used by the present method. Thus, the method-related discharge parameter of the amount of particulate building material 2 to be discharged per unit of time or the method-related discharge parameter of the amount of particulate building material 2 to be discharged per area can be controlled or regulated by the number of porous gas outlet means 18 used. Another option for controlling or regulating these discharge parameters is the gas pressure used for the porous gas outlet means 18.

In a special variant, the gas pressure can, for example, be generated in a pulsating manner, as a result of which an improvement in the fluidization is possible and the quantity of the particulate building material 2 released can also be changed over time.

FIG. 4 shows an enlarged excerpt of the area of the building material curtain 6 and the building material accumulation 20 on the construction site 4. FIG. 4 also shows the applicator 1 with its outlet 5. A means 9a for optically monitoring the building material curtain 6 with its receiving area 10a is also shown. The thickness 11 of the curtain of building material 6 is also shown.

Another means 9b for the optical monitoring of the building material accumulation 20 is shown in FIG. The depiction of the means 9 in FIG. 4 is only a basic sketch and does not represent either the exact proportions or the exact positions of the means 9, which can be arranged as required. Depending on their positioning, the means 9 can thus show a front view, a side view or a perspective view of the building material curtain 6 and/or the building material accumulation 20.

Dimensions of the triangular-prism-shaped building material accumulation 20 with its triangular base area or top area that can be determined according to the method are shown with a height 22, a width 25, one of the inner angles 23 and an angle of slope 24.

The length 21 of the build piling 20 is not shown in FIG. 4 because FIG. 4 shows a side view of the build piling 20 in which the length 21 of the build piling 20 would extend into the depth of the illustration.

### LIST OF REFERENCES

1 Applicator/means for discharging the particulate building material/fluidizer
2 particulate building material
3 Means for smoothing/blade
4 construction site
5 Outlet for particulate building material
6 building material curtain
7 direction of movement
8 layer thickness
9, 9a, 9b Means of optical surveillance/camera
10, 10a, 10b recording area
11 Thickness of building material curtain
12 Angle of building material curtain
13 Length of building material curtain
14 Height of building material curtain
15 Reservoir
16 blocking agent
17 ventilation gap
18 porous gas venting means
19 gas connection
20 Accumulation of building material (with imaginary triangular base area or top surface of the triangular prism-shaped accumulation of building material)
21 Length of building material accumulation
22 Height of building material accumulation
23 Interior angle of building material accumulation
24 Departure angle of building material accumulation

1-9. (canceled)

10. A method for discharging particulate building material in a 3D printer, in which the particulate building material is discharged from an applicator forming a building material curtain striking a building field creating a building material accumulation, the method comprising the steps of:
optical monitoring by generating an image of the particulate building material in the building material curtain and/or the building material accumulation;
based on the generated image of the particulate building material, determining at least one dimension of the particulate building material;
comparing the generated image of the particular building material with an associated reference image and/or or the at least one dimension of the particulate building material with an associated reference value; and
if the generated image of the particulate building material deviates from the associated reference image and/or the at least one dimension of the particulate building material deviates from the associated reference value, changing at least one discharge parameter associated with a quantity of the particulate building material to be discharged from the applicator.

11. The method according to claim 10, wherein the optical monitoring is from at least one direction onto the building material curtain and/or the building material accumulation, with the generated image representing at least a section of the building material curtain and/or the building material accumulation; and the generated image represents a side view, a front view and/or a perspective view.

12. The method according to claim 10, wherein the determined at least one dimension of the building material curtain is length, height, thickness or an angle between a surface of the building field and the building material curtain.

13. The method according to claim 10, wherein the determined at least one dimension of the building material accumulation is length, height, width, an interior angle or an angle of slope.

14. The method according to claim 10, wherein the at least one discharge parameter for the particulate building material changed is: (i) a quantity of the particulate building material to be discharged per unit of time; (ii) a quantity of the particulate building material to be discharged per area; (iii) a movement speed of applicator of the 3D printer over a surface of the building field; or (iv) a change in quantity of the particulate building material to be discharged over time.

15. The method according to claim 14, wherein the at least one discharged parameter for the particulate building material changed is the change in the quantity of the particulate building material to be discharged over time with a fixed frequency or a frequency which changes over time.

16. The method according to claim 10, wherein the optical monitoring of the particulate building material is divided into partial areas of the building material curtain and/or the building material accumulation.

17. The method according to claim 16, wherein a sum of the partial areas covers an entire area of the building material curtain and/or an entire area of the building material accumulation.

18. The method according to claim 16, wherein the at least one discharge parameter for the discharge of the particulate building material are changed differently in the partial areas.

19. The method according to claim 14, wherein the changing of the at least one discharge parameter representing the quantity of the particulate building material to be discharged per unit of time and/or the quantity of the particulate building material to be discharged per area comprises the step of controlling a number of gas porous outlet associated with the applicator and/or a pressure of gas acing upon the gas porous outlet.

20. The method of claim 10, wherein the generated image is an image, a sequence of images or a video from the generated image.
